(19) United States
(12) Patent Application Publication
(10) Pub. No.: US 2016/0275146 A1
(43) Pub. Date: Sep. 22, 2016

(54) USE A PARALLEL HARDWARE SEARCH DEVICE TO IMPLEMENT BIG DATABASES EFFICIENTLY

(71) Applicant: Koutin Technology Inc. LTD, Taoyuan City (TW)

(72) Inventor: WEN-LUNG SHU, Taoyuan City (TW)

(21) Appl. No.: 15/170,281

(22) Filed: Jun. 1, 2016

Related U.S. Application Data
(63) Continuation-in-part of application No. 14/160,622, filed on Jan. 22, 2014, now Pat. No. 9,384,449.

(30) Foreign Application Priority Data
Oct. 4, 2013 (TW) 102136037

(51) Int. Cl. G06F 17/30; G06N 99/00

(52) U.S. Cl. CPC G06F 17/30507; G06F 17/30327; G06N 99/005

(57) ABSTRACT

A parallel hardware searching device (PHSD) is used to build an artificial intelligent computer, wherein the system mainly contains a hardware search module and several DRAM (or universal memory) modules, said hardware search module comprises: a processing unit (PU) architecture contains mainly a comparator and controller, m PUs which are connected with m BRAM units and one Inter Processing Unit Logic, PU only process the data in its own BRAM unit, PUs are also connected to Inter Processing Unit Logic (IPUL) which processes the functions between PUs; a PCIE interface controller which is used to connect search module to external PC, search module use PCIE to receive data or command from PC, or transmit data to PC; a PHDS includes a controller which is used to execute 5 commands: Search, Insertion, Deletion, Load to BRAM and Store to DRAM.

### CROSS-REFERENCE TO RELATED APPLICATION

This application is a continuation-in-part application of U.S. application Ser. No. 14/160,622 filed on Jan. 22, 2014.

### BACKGROUND OF THE INVENTION

1. Field of the Invention

Search and sort are considered as the most important two operations in computer system. New sorting method is invented in the patent, using parallel search and parallel insert operations. Big databases can be efficiently sorted by constructing a B-tree structure. PC flexibly executes software control program to perform simple operations and instruct a Parallel Hardware Search Device (PHSD) to process complex database operations over big data. Therefore, this computer system can effectively implement all database operations, and can be considered as a Database Machine. It implements knowledge bases also and can be used as an AI Machine.

2. Description of the Related Art

In previous patent “A Parallel Hardware Search System for Building Artificial Intelligent Computer” (U.S. patent application Ser. No. 14/160,622, Taiwan patent TW application No.: 102218650, China patent application No.: 201320658123.5). The index file is used to construct a number of hierarchical paging tables, and the size of paging table is limited by allowing only one or several search operations to be processed in table. In order to process search operation, several equations have to be implemented in each Processing Unit (PU). It is mathematically proved that search can be processed on parallel without causing any data conflict and communication problems.

B-tree is the most commonly used method in traditional database system since the deficiencies of hashing. In this invention, big data can be randomly retrieved by constructing index file into a big B-tree structure. The paging tables are partitioned into a number of smallest segments, such that only one comparison and one level are allowed to parallel search each segment. In this case, DLB=0 and BlockSize=1. Mathematical equations are not required to calculate DLB, BlockSize and LOCATION. The equations in PU are further optimized. PU number in the chip can be increased tremendously. Assume PU number is extended to 128 in Xilinx FPGA kintex chip. PU128 is always in the rest state for search operation.

B-tree data structure can be generated by asking PHSD to process 5 hardware commands: Search, Insertion, Deletion, Load into BRAM, and Store into DRAM. PC executes software control program to sorting big data by performing simple operations and instructing PHSD to process commands over big data for complex database operations. Hence, this approach can efficiently implement all database operations over very large databases and knowledge bases.

### SUMMARY OF THE INVENTION

An artificial intelligent computer system is developed by combining PC with a PHSD. PC uses software control program to execute simple operations and instruct PHSD to execute 5 commands: search, deletion, insertion, load and store. To search B-tree sorting structure, PC loads root data segment from DRAM to BRAM, 128 PUs of PHSD compare the segment with criterion, and find PATH value. In this path, PU contains a record where segment number and segment size can be found for next level. Then load this segment to another BRAM address. Repeat the process until final segment is processed. The pointer of database record can be searched if search criterion exist in the index file at Level=0. Otherwise, inserting position can be found if criterion does not exist.

New sorting device is invented by using PHSD search command to find inserting position. After PHSD insertion command is execute, segment data size is increased, and data size in each searching path from LEVEL=0 to top level need to detect if size is 128. Assume Segment data size be 128 in LEVEL=i, this segment have to split into two segments. Several operations are processed to maintain a complete B-tree structure in DRAM. Repeat such processes, then a big B-tree data structure will be gradually constructed in DRAM.

Complex database operations in relational algebra and aggregate functions can be implemented by using this type of sorting system. This device can also be used to implement knowledge bases in artificial intelligent field. The programming grammar is upgraded from context-free to Turing machine.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a database machine which combines PC with a parallel hardware search device (PHSD).

FIG. 2 is B-tree structure that is built by using search and insertion operations.

### DETAILED DESCRIPTION OF THE PREFERRED EMBODIMENTS

The technical content of the present invention will become apparent by the detailed description of the following embodiments and the illustration of related drawings as follows.

In previous patent (Pub No.: US2015/0100536 A1), several equations have to be implemented in each PU. In this invention, big data can be randomly retrieved by constructing index file into a big B-tree structure. The paging tables are the smallest segments. Only one comparison and one level are allowed in each segment. Therefore, DLB=0 and BlockSize=1. Mathematical equations are not required to calculate DLB, BlockSize and LOCATION. PU number in the chip can be greatly increased. Fast parallel hardware search and insertion are combined to form a high performance hardware sorter used to implement databases and knowledge bases.

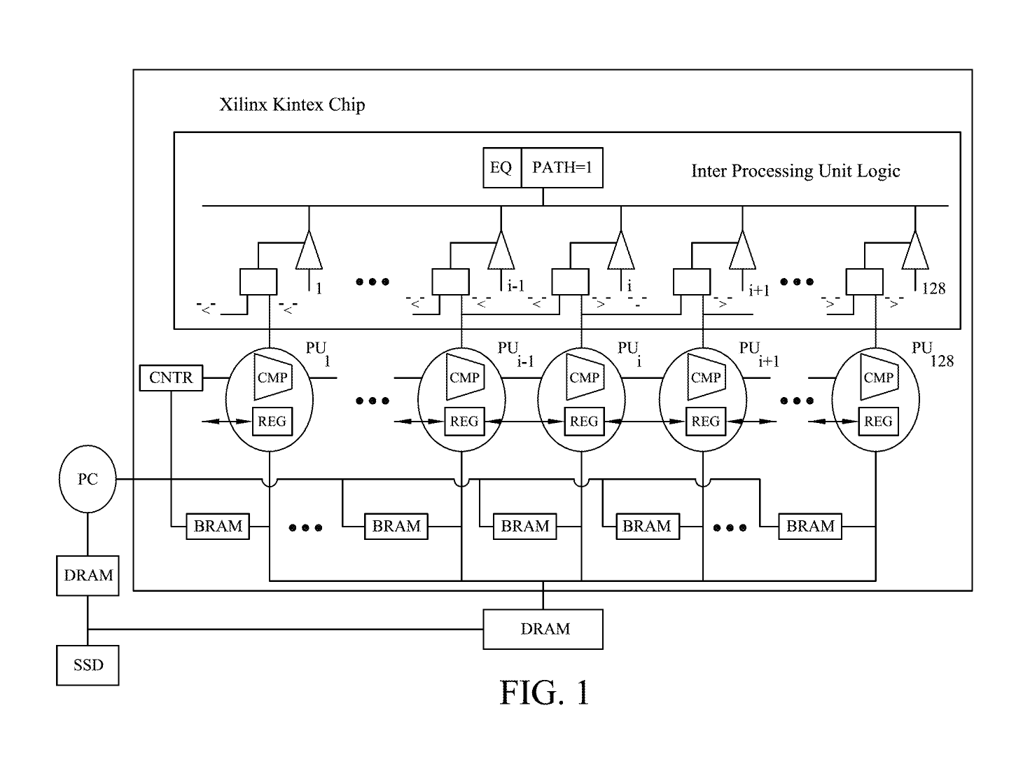

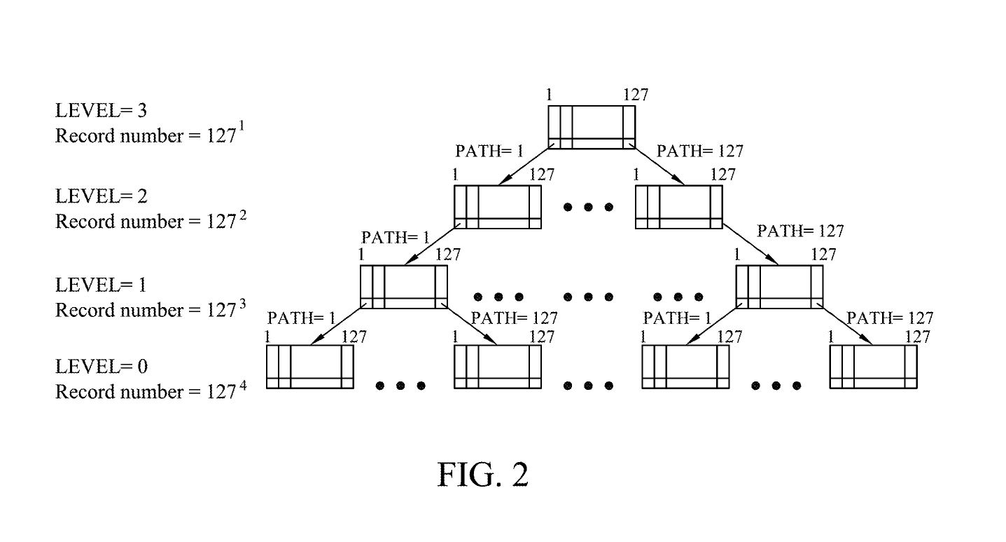

A database machine is designed by combining PC with a PHSD in FIG. 1. The index file record includes search value field and 64-bit pointer field. In FIG. 2, each node of B-tree is denoted as “segment”. Maximum record number is 127 in a segment. Index file records are sorted and partitioned into a number of segments at LEVEL=0. This pointer contains 32-bit page number, 16-bit offset and one bit to present valid or empty record. This pointer can be used to fast access database record. Records in the segments from LEVEL=1 to top level also includes search value field and 64-bit segment pointer field. Pointer field contains 4-byte next segment's number and 2-byte segment's size. Each segment can be loaded from DRAM at start address=(segment number−1)*segment size, and 127 records of this segment are distributed to 127 BRAM modules with start address=RecordSize*LevelNumber. After comparing 127 search values with criterion, 7-bit PATH and 1-bit EQ are generated. Then PC store PATH value into pathArray[TopLevel]. The next segment's number and size for next level can be found in the record of PU whose index equal to PATH. Continue to process these operations from level=TopLevel to 0. Finally, Insertion is performed by inserting criterion record into the PATH location of final segment at level=0 if criterion does not exist. Hence, a big B-tree structure can be constructed by repeating these processes. If criterion does exist, then final pointer can be used to access database record.

PHSD executes 5 hardware commands: search, deletion, insertion, load and store using one port of BRAM. PC's software can maintain B-tree structure through PCIE and another port of BRAM. These five hardware commands are described below:

1. Search: If PU index is greater than segment data size, comparing result must be “>”. Otherwise, search values in PUs are compared with criterion using 32-bit comparators. The PU index will be transferred into 7-bit register PATH if the comparing result of this PU is “>” or “=”, and the result of left adjacent PU is “<”. If the comparing result of any PU is “=”, one-bit register EQ=1. Otherwise, EQ=0.

2. Insertion: Insertion operation is executed at level 0 after search from Top level to level 1. If search value is not exist (EQ=0), All records whose PU index greater PATH have to be shifted left one position. Then a new criterion record is inserted into PU whose index is equal to PATH.

3. Deletion: To execute deletion operation, search criteria is found at PU whose index is equal to PATH and EQ=1. Records whose PU index greater than PATH are shifted right one position.

4. Load data to BRAM: DRAM controller is used to load data segment from DRAM to BRAM. At each LevelNumber, BRAM start address is calculated as 127*RecordSize*LevelNumber. PATHArry[LevelNumber] stores the PATH value generated in this level, after PUs compare data segment records with criterion.

5. Store data to DRAM: PC can store data segment back from BRAM to DRAM. PC can also retrieve a new segment located in DRAM. The DRAM start address is: (SegmentNumber−1)*127*RecordSize.

The procedures to search B-tree from top level to bottom level are as follows:

```
Search( criterion, pointer){
  Input the segment number and segment size of top level segment.
  for(int k=TopLevel:k=0;k--){
```

Load segment at level k from DRAM to BRAM.
Compare criterion with segment records on parallel using 128 PUs.
Get the record whose comparing result is “>=” and left adjacent result is “<”.
The segment number and segment size of next level segment can be found in this record.

```
  }
  If search result is not found and only finds the segment position at level=0, a new record whose search
```

value is criterion, can be inserted into this location of the segment. Segment size is increased by 1 in
previous record pointing to this segment.

In other case, the search result is found and last record in level 0 containing the result pointer with page

number and offset. This pointer is used to access a database record.

}

As shown in the above procedures, PC uses segNumArray[TopLevel] and segSizeArray[TopLevel] to access first root data segment and distribute index records to the corresponding BRAM modules. Every PU has its own BRAM modules. At level=i where i is from TopLevel to 1, PHDS retrieves and compares this level segment, and generates PATH value. Then PC stores PATH into PATHArray[i]. From the record in the path, PC gets and stores segment number, segment size of next level segment into segNumArray[i−1] and segSizeArray[i−1]. At level=0, If the final search result is found, then pointer is used to access database record. Otherwise, last PATH value represents the resulting search position, and record containing criterion can be inserted into this position. At previous level, segment size in the record pointing to this segment must be increase by 1.

The procedures to detect and split data segment from bottom level to top level are as follows:

DetectSplit( ){
for (int i=0;i<= TopLevel 0;i++){

```
if (segment size of the segment at level i ==128){
  The segment are partitioned into two half segments and their edge records with their pointers are
  collected.
  if (i==TopLevel){
```

Two half segments are stored into DRAM. Lower half segment is still in BRAM.
TopLevel=TopLevel+1;
New segment with two edge records are created in TopLevel and stored into BRAM and DRAM.

```
  } else
  { Upper half is stored into DRAM, and lower half stay in old BRAM and DRAM location.
```

segment size in edge records are modified. Edge record of Upper half is inserted into previous
segment at level i+1. segment size of the pointing recored at level i+2 is increased by 1 if i+2 exist.

}
} else {break;}

```
  }
  }
```

Then above DetectSplits procedures is used to detect segment sizes from LEVEL=0 to top level. The segment has to be split into two segments if size=128. Data segment are partitioned into two half segments and their edge records are collected. Two cases are possible: In case1, LEVEL is TopLevel, and segment is split. TopLevel is increased by 1. New segment contains two edge records with edge search values and pointers pointing to split segments. In case 2, LEVEL is between 0 to TopLevel−1. The segment is split and segment sizes of edge records are modified. Edge record of Upper half is inserted into previous segment at level i+1. Segment size of the pointing record in level=i+2 will be increased by 1, when level i+2 exists.

The procedures to construct B-tree data structure are as follows:

```
ConstructBtree( ){
  Create first segment in BRAM and store first record with maximum
  values in the segment.
  for( int n=0;n<N;n++){
```

Use Search( ) to find the insert position in level 0;
Insert an input record n into segment to construct B-tree, when
criterion is not found.
segment size of the record pointing to this segment is increased by 1;
Use DetectSplit( ) to check and split the segment into two halves
when segment size =128.

```
  }
  Finally, restore all segments in BRAM back to their locations in DRAM.
}
```

As shown in the above procedures, let a database relation contains N records and an index file is used for search operation. Create first segment in BRAM and store first record with maximum values in the segment. Then retrieve index file records from 1 to N, and input to B-tree. Use Search( ) to find the insert position in level 0; Then insert an input record into segment to construct B-tree, when criterion is not found. Segment size in the record pointing to this segment is increased by 1. Use DetectSplit( ) to check and split the segment into two halves when segment size=128 Finally, restore all segments in BRAM back to their DRAM locations.

Since very large databases can be sorted by constructing B-tree, databases records can be sorted and partitioned into segments in LEVEL=0. Complex database operations processed by PHSD are described below:

1. Random selection: Index file records including a search attribute value and a record pointer are created. These records are sorted and constructed a B-tree to process fast random selection.

2. Equi-join: Index file records containing search value key and pointer used to access a pointer array which is created to access many corresponding relational records. This approach is used for equi-join.

3. Delete duplicates and Union: To delete duplicate records from one relation in projection, or to process union for two operand relations, one relation records are constructed into B-tree. Then another relation records are inserted into B-tree. If duplicate record exists, comparing result EQ=1 and insertion is not performed. Final B-tree will be the result.

4. Intersection: One operand relation records are input to construct B-tree first. Then another operand relation records are used to search. If duplicate record exists in B-tree, these records are collected as the resulting relation for intersection.

5. Minus: One operand relation records are input to construct B-tree first. Then another operand relation records are used to delete duplicate record in B-tree. The resulting relation can be generated in remaining B-tree.

6. Aggregate functions over groups: A relation records are input to construct B-tree and their group attribute values are used as sorting key. After that, sorting records are retrieved one by one. Count or SUM can be processed for each group. AVE can be calculated using SUM/COUNT.

7. Division: Divisor relation records are input to construct B-tree first, and record number of this relation is counted. Then dividend relation records are input to B-tree, and divisor field values are used as criterion. The quotation field values are collected as a relation. Latter, count over groups is processed in this relation. The group attribute values are collected as quotient when their count value=divisor record number.

Knowledge bases can be implemented as the PROLOG statements. Horn clauses are stored into character field with variant size in postgreSQL relation hornclause. Each horn clause in relation hornclause has a start address pointer including page number and offset. Relation searchfile has function names and pointer array. In searchfile, function names and their pointer values are built into B-tree. Search B-tree to find pointer, then access pointer array and corresponding horn clauses. These relations are shown below:

1. Relation hornclause:

tid=(0,1) factorial(0,1).

tid=(0,2) factorial(X,Y):−X1=X−1, factorial(X1,Z), Y=X*Z.

tid=(0,3) child_of(joe,ralf).

tid=(0,4) child_of(mary,joe).

tid=(0,5) child_of(steve,joe).

tid=(0,6) decendent_of(X,Y) child_of(X,Y).

tid=(0,7) decendent_of(X,Y) child_of(Z,Y), decendent_of(X,Z).

2. Relation searchfile:

tid=(0,1) factorial tidy={“(0,1)”,“(0,2)”}

tid=(0,2) child_of tidy={“(0,3)”, “(0,4)”, “(0,5)”}

tid=(0,3) decendent_of tidy={“(0,6)”, “(0,7)”, “(0,3)”,“(0,4)”,“(0,5)”}

Prolog horn clauses are considered as objects and traditional host language like c++, Java can be used as methods. Software automation system can be developed to solve software crisis in software engineering field.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A parallel hardware searching device (PHSD) is used to build an artificial intelligent computer, wherein the device mainly contains a hardware search module and several DRAM (or universal memory) modules, said hardware search module comprises:
a processing unit (PU) architecture contains mainly a comparator and controller, m PUs which are connected with m BRAM units and one Inter Processing Unit Logic, PU only process the data in its own BRAM unit, PUs are also connected to Inter Processing Unit Logic (IPUL) which processes the functions between PUs;
a PCIE interface controller which is used to connect search module to external PC, search module use PCIE to receive data or command from PC, or transmit data to PC; PHDS includes a controller which is used to execute 5 commands: Search, Insertion, Deletion, Load to BRAM and Store to DRAM using a port of BRAM, and PC maintains complete B-tree structure using another port of BRAM.

2. The device of claim 1, wherein Search is used to find search value in B-tree from top level segment to bottom level; in each level, search values of 128 PUs are compared with criteria; the PU's index will be transferred into 7-bit register PATH if the comparing result of this PU is “>” or “=”, and the result of left adjacent PU is “<”; one-bit register EQ=1, if the comparing result of any PU is “=”; otherwise, EQ=0; PATH value is used to retrieve segment in B-tree next level; final resulting pointer is used to access database record, if criterion is found at LEVEL=0, or final PATH position is used for insertion if criterion is not found.

3. The device of claim 1, wherein Search is processed to find inserting position and EQ=0 in order to insert new index record. The records after this position are shift left one position and new record is inserted; segment size in the pointer of this segment is incremented by 1; then segment sizes in each search path have to be detected; if segment size is 128, segment is split into two segments with data size=64; then, process several operations to maintain a complete B-tree structure.

4. The device of claim 1, wherein a new sorting method for big data is designed by using PHSD to search inserting position in B-tree and insert new record to this position; a database relation records are input to B-tree one by one; then detect and split segment if data size is 128; big data can be sorted as a B-tree and stored in DRAM.

5. The device of claim 1, wherein since very large databases can be sorted by using B-tree, complex database operations processed by PHSD are listed below: Search, join, delete duplicates in projection, intersection, union, difference, division and aggregates over groups.

6. The device of claim 1, wherein knowledge base representing as prolog language can be efficiently implemented using the hardware system described in claim 1.
